(19) United States
(12) Patent Application Publication
(10) Pub. No.: US 2008/0204368 A1
(43) Pub. Date: Aug. 28, 2008

(54) ELECTRONIC IMAGING DEVICE

(76) Inventors: Seong-Cheol Han, Uijeongbu-si (KR); Hui Nam, Yongin-si (KR); Hyoung-Wook Jang, Yongin-si (KR)

Correspondence Address: CHRISTIE, PARKER & HALE, LLP, PO BOX 7068, PASADENA, CA, 91109-7068, US

(21) Appl. No.: 11/923,581

(22) Filed: Oct. 24, 2007

(30) Foreign Application Priority Data
Feb. 27, 2007 (KR) 10-2007-0019584

(51) Int. Cl. G09G 3/20

(52) U.S. Cl. 345/55

(57) ABSTRACT

An electronic imaging device capable of displaying a planar image or a stereoscopic image. The electronic imaging device includes a display unit and a barrier layer. The display unit includes a plurality of scan lines for transferring a plurality of selection signals, a plurality of data lines for transferring a plurality of data signals, and a plurality of pixels connected to the pluralities of data lines and scan lines. The barrier layer is adapted to operate in synchronization with the selection signals. The barrier layer includes at least one sub-barrier corresponding to a first scan line among the plurality of scan lines, and is adapted to operate in synchronization with at least one of the selection signals transferred to the first scan line.

### CROSS-REFERENCE TO RELATED APPLICATION

This application claims priority to and the benefit of Korean Patent Application No. 10-2007-0019584 filed in the Korean Intellectual Property Office on Feb. 27, 2007, the entire content of which is incorporated herein by reference.

### BACKGROUND OF THE INVENTION

1. Field of the Invention

The present invention relates to an electronic imaging device, and more particularly, to an electronic imaging device for displaying a normal planar image and/or a stereoscopic image according to an input signal.

2. Description of the Related Art

In general, humans perceive a stereoscopic effect based on a physiological factor and an experiential factor, and a three-dimensional image displaying technology expresses a stereoscopic effect of an object by using a binocular parallax, which is a primary factor for allowing humans to recognize a stereoscopic effect at a short distance.

Electronic imaging devices generally display a stereoscopic image by spatially separating an image into a left image and a right image using optical elements. Representative examples of the optical elements used to display a stereoscopic image include a lenticular lens array and a parallax barrier.

Recently, an electronic imaging device capable of displaying both of a normal planar (or two-dimensional) image and a stereoscopic image was developed and has become commercially available.

However, image quality of an electronic imaging device that can selectively display a planar image and a stereoscopic image may deteriorate due to the operating characteristics of optical elements. Particularly, the image quality is deteriorated when a planar image changes to a stereoscopic image and vice versa. That is, when a planar image changes to a stereoscopic image, all of the optical elements simultaneously switch to a driving mode to display a stereoscopic image. Then, if a planar image is displayed on a certain area of a display screen (that may be predetermined), the planar image is displayed through the optical elements in the driving mode to display the stereoscopic image. Similarly, when a stereoscopic image changes to a planar image, all of the optical elements switch to a transmission area. Here, if a stereoscopic image is displayed on a certain area of a display screen (that may be predetermined), the stereoscopic image is displayed through the transmission area.

As such, the image quality is deteriorated when a planar image changes to a stereoscopic image or vice versa because the operating state of the optical elements is not matched with a certain area of a display screen.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention is directed to an electronic imaging device having an optical element layer that is capable of being synchronized with a displaying image.

An exemplary embodiment of the present invention provides an electronic imaging device including a display unit and a barrier layer. The display unit includes a plurality of scan lines for transferring a plurality of selection signals, a plurality of data lines for transferring a plurality of data signals, and a plurality of pixels connected to the pluralities of data lines and scan lines. The barrier layer is adapted to operate in synchronization with the selection signals. The barrier layer includes at least one sub-barrier corresponding to a first scan line among the plurality of scan lines, and is adapted to operate in synchronization with at least one of the selection signals transferred to the first scan line.

In one embodiment, the at least one sub-barrier includes at least one first sub-barrier formed to correspond to at least one of the plurality of scan lines in a first direction when the plurality of selection signals are transferred to the plurality of scan lines in the first direction. In one embodiment, at least two scan lines of the plurality of scan lines correspond to the at least one first sub-barrier, and the at least one first sub-barrier is adapted to operate in synchronization with a first applied selection signal among the selection signals applied to the at least two scan lines. The at least one first sub-barrier may include a plurality of first electrodes corresponding to the plurality of data lines and a first connection electrode for connecting the plurality of first electrodes. A first voltage may be applied to the plurality of first electrodes by being synchronized with the first applied selection signal when a stereoscopic image is displayed on the display unit. The at least one sub-barrier may also include at least one second sub-barrier formed to correspond to at least one of the plurality of scan lines in a second direction when the plurality of selection signals are transferred to the plurality of scan lines in the second direction.

In one embodiment, the barrier layer further includes a first barrier layer and a second barrier layer, wherein the first barrier layer includes at least one first sub-barrier of the at least one sub-barrier, formed to correspond to at least one of the plurality of scan lines in a first direction when the plurality of selection signals are transferred to the plurality of scan lines in the first direction, and the second barrier layer includes at least one second sub-barrier of the at least one sub-barrier, formed to correspond to at least one of the plurality of scan lines in a second direction when the plurality of selection signals are transferred to the plurality of scan lines in the second direction. In one embodiment, at least two scan lines of the scan lines correspond to the at least one second sub-barrier, and the at least one second sub-barrier is adapted to operate in synchronization with a first applied selection signal among the selection signals applied to the at least two scan lines. The at least one second sub-barrier may include a plurality of second electrodes corresponding to the plurality of scan lines and a second connection electrode for connecting the second electrodes. A first voltage may be applied to the plurality of second electrodes by being synchronized with the first applied selection signal when a stereoscopic image is displayed on the display unit.

In one embodiment, each of the pixels includes an organic light emitting element.

In one embodiment, the electronic imaging device further includes a light source for providing light to the display unit, wherein each of the pixels of the display unit includes a liquid crystal layer.

Another embodiment of the present invention provides an electronic imaging device including a display unit and a plurality of barriers. The display unit includes a plurality of scan lines for transferring a plurality of selection signals, a plurality of data lines for transferring a plurality of data signals, and a plurality of pixels connected to the pluralities of data lines and scan lines. The plurality of barriers includes a plurality of barrier cells. The plurality of barrier cells are adapted to form a plurality of first sub-barriers in a first direction corresponding to a first scan direction of transferring the plurality of selection signals to the plurality of scan lines, respectively, and the first sub-barriers are adapted to synchronize with the selection signals corresponding to a plurality of first scan lines among the plurality of scan lines.

In one embodiment, the plurality of barrier cells are further adapted to form a plurality of second sub-barriers in a second direction corresponding to a second scan direction of transferring the plurality of selection signals to the plurality of scan lines, and the second sub-barriers are adapted to operate in synchronization with the selection signals of a plurality of second scan lines among the plurality of scan lines. In one embodiment, the plurality of barrier cells are disposed corresponding to the plurality of pixels, a first barrier cell and a second barrier cell among the plurality of barrier cells forming a first barrier corresponding to the first scan lines of an area for displaying a stereoscopic image in the display unit are adjacent to each other, and one of the first barrier cell or the second barrier cell is a non-transmission area. In one embodiment, the plurality of second sub-barriers are disposed corresponding to the plurality of second scan lines, and a first set of the second sub-barriers corresponding to the second scan lines of an area for displaying a stereoscopic image in the display unit forms a non-transmission area, and a second set of second sub-barriers adjacent to the second sub-barriers in the stereoscopic display area forms a transmission area.

Another embodiment of the present invention provides an electronic imaging device including a display unit and a barrier. The display unit includes a plurality of scan lines for transferring a plurality of selection signals, a plurality of data lines for transferring a plurality of data signals, and a plurality of pixels connected to the pluralities of data lines and scan lines. The barrier includes a plurality of barrier cells. A plurality of first barrier cells of the plurality of barrier cells corresponding to a first area for displaying a stereoscopic image in the display unit are adapted to operate in synchronization with a timing of the selection signals transferred to each of the plurality of scan lines corresponding to the first area.

In one embodiment, a first barrier cell and a second barrier cell of the first barrier cells are adjacent to each other in a first direction, and one of the first barrier cell or the second barrier cell is a non-transmission area. In one embodiment, a plurality of second barrier cells of the plurality of barrier cells continuously form a non-transmission sub-barrier in a second direction, and other sub-barriers, formed by a plurality of third barrier cells of the plurality of barrier cells, adjacent to the non-transmission sub-barrier form a transmission area.

In one embodiment, the first barrier cells continuously form a non-transmission sub-barrier in a first direction, and other sub-barriers, formed by a plurality of second barrier cells of the plurality of barrier cells, adjacent to the non-transmission sub-barrier form a transmission area.

### BRIEF DESCRIPTION OF THE DRAWINGS

FIG. 1 is a block diagram schematically illustrating an electronic imaging device according to an exemplary embodiment of the present invention.

FIG. 2 schematically illustrates a pixel circuit according to an exemplary embodiment of the present invention.

FIG. 3 schematically illustrates a first barrier according to an exemplary embodiment of the present invention.

FIG. 4 schematically illustrates a second barrier according to an exemplary embodiment of the present invention.

FIG. 5 schematically illustrates a display unit and a first barrier for describing the operation of the display unit and the first barrier according to an exemplary embodiment of the present invention.

FIG. 6 schematically illustrates a first barrier driving control signal corresponding to a selection signal.

FIG. 7 schematically illustrates a display unit and a second barrier for describing the operation of the display unit and the second barrier according to an exemplary embodiment of the present invention.

FIG. 8 schematically illustrates a second barrier driving control signal corresponding to a selection signal.

FIG. 9 schematically illustrates an electronic imaging device according to a second exemplary embodiment of the present invention.

FIGS. 10A and 10B schematically illustrate a barrier of an electronic imaging device according to a third exemplary embodiment of the present invention.

FIG. 11 is a cross-sectional schematic view of the barrier of FIG. 10B taken along the line A-A′.

FIG. 12 schematically illustrates an electronic imaging device according to the third exemplary embodiment of the present invention.

FIG. 13 schematically illustrates operation of a barrier when a planar image changes to a stereoscopic image in an electronic imaging device according to the third exemplary embodiment of the present invention.

FIG. 14 schematically illustrates operation of a barrier when the display unit of FIG. 13 rotates at 90° and a planar image changes to a stereoscopic image in a second scan direction.

FIG. 15 schematically illustrates a stereoscopic image displayed at a portion of a display unit (that may be predetermined) according to the third exemplary embodiment of the present invention.

FIG. 16 schematically illustrates a stereoscopic image displayed at an area of a display unit (that may be predetermined) according to the third exemplary embodiment of the present invention.

FIG. 17 illustrates an electronic imaging device according to a fourth exemplary embodiment of the present invention.

FIG. 18 illustrates a pixel circuit according to the fourth exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that a first element is “coupled” or “connected” to a second element, the first element may be “directly coupled” or “directly connected” to the second element or be “electrically coupled” or “electrically connected” to the second element through one or more other elements. In addition, unless explicitly described to the contrary, the word “comprise”, and variations such as “comprises” and “comprising”, will be understood to imply the inclusion of stated elements but not the exclusion of any other elements.

Hereinafter, an electronic imaging device and a driving method thereof according to an exemplary embodiment of the present invention will be described.

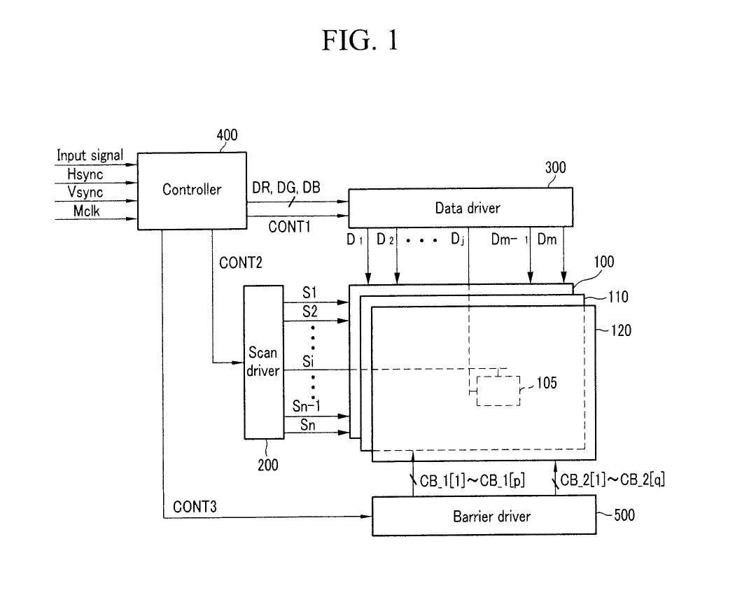

FIG. 1 is a block diagram schematically illustrating an electronic imaging device according to an exemplary embodiment of the present invention.

As shown in FIG. 1, the electronic imaging device according to one embodiment of the present exemplary embodiment is an imaging device that can selectively display a planar image and a stereoscopic image, and includes a display unit (or display region) 100, a first barrier 110, a second barrier 120, a scan driver 200, a data driver 300, a controller 400, and a barrier driver 500.

The display unit 100 includes a plurality of scan lines S1 to Sn for transferring selection signals, a plurality of data lines D1 to Dm insulated from and crossing the plurality of scan lines S1 to Sn and for transferring data signals, and a plurality of pixels 105 formed at crossings of the scan lines S1 to Sn and the data lines D1 to Dm. In the present exemplary embodiment, each of the pixels 105 includes a red subpixel for displaying red (R) color, a green subpixel for displaying green (G) color, and a blue subpixel for displaying blue (B) color. In the present exemplary embodiment, the plurality of pixels 105 in the display unit 100 include pixels corresponding to a left-eye image (hereinafter, also referred to as ‘left-eye pixels’) and pixels corresponding to a right-eye image (hereinafter, also referred to as ‘right-eye pixels’). The left-eye pixels and the right-eye pixels are alternately and/or repeatedly arranged. In more detail, the left-eye pixels and the right-eye pixels are alternately and/or repeatedly arranged in parallel, thereby forming a stripe pattern and/or a zigzag pattern. The arrangement of the left-eye pixels and the right-eye pixels may be changed according to the first and second barriers 110 and 120. The pixels 105 of the display unit 100 according to one embodiment include one or more organic light emitting elements (or diodes) and one or more pixel circuits for driving the one or more organic light emitting diodes.

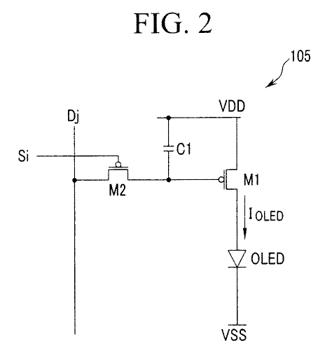

FIG. 2 is a diagram schematically illustrating a pixel circuit of a pixel according to an exemplary embodiment of the present invention.

Referring to FIG. 2, a pixel circuit of a pixel 105 according to one embodiment of the present exemplary embodiment includes a driving transistor M1, a switching transistor M2, a capacitive element C1, and an organic light emitting diode (OLED). The OLED has diode characteristics, and has a structure that includes an electrode layer (anode), an organic thin film, and a cathode electrode layer (cathode).

The pixel circuit is formed at each crossing of one scan line Si among the plurality of scan lines and one data line Dj among the plurality of data lines, and is connected to each scan line and the data line. The driving transistor M1 generates a driving current corresponding to a voltage applied to its gate electrode and its source electrode. The switching transistor M2 is turned on in response to a selection signal transferred from the scan line Si, and when the switching transistor M2 is turned on, the data signal transferred from the data line Dj is transferred to the gate electrode of the driving transistor M1. The capacitive element C1 has first and second ends respectively connected to the gate electrode and the source electrode of the driving transistor M1, and uniformly sustains the voltages of the first and second ends. Then, the driving transistor M1 generates a driving current IOLED corresponding to a difference between the voltage of the data signal transferred to the gate electrode of the driving transistor M1 and a power source voltage VDD applied to the source electrode of the driving transistor M1. The generated driving current IOLED flows to the OLED through a drain electrode of the driving transistor M1. The OLED emits light corresponding to the driving current IOLED.

The scan driver 200 is connected to the scan lines S1 to Sn of the display unit 100 and applies a selection signal formed of a combination of a gate on voltage and a gate off voltage to the scan lines S1 to Sn. The scan driver 200 may apply the selection signals to the plurality of scan lines S1 to Sn to sequentially have a gate on voltage. When the selection signal has the gate on voltage, the switching transistor connected to the scan line is turned on.

The data driver 300 is connected to the data lines D1 to Dm of the display unit 100, and applies a data signal representing a gray level to the data lines D1 to Dm. The data driver 300 converts input image data DR, DG, and DB, which are input from the controller 400 and have gray level information, to a voltage-type or a current-type data signal.

The controller 400 receives an input signal IS, a horizontal synchronization signal Hsync, and a vertical synchronization signal Vsync, generates a scan control signal CONT1, a data control signal CONT2, an image data signal DR, DG, or DB, and a barrier driver control signal CONT3, and respectively transfers the generated signals to the data driver 300, the scan driver 200, the data driver 300, and the barrier driver 500. The scan control signal CONT1 includes a scan start signal for instructing to start scanning and a first clock signal. The data control signal CONT2 includes a horizontal synchronization start signal for instructing transferring of input image data for pixels of one row and a second clock signal. The controller 400 may transfer the input image data DR, DG, and DB through three channels by color when input image data for one row is transferred to the data driver 300, or may sequentially transfer the input image data DR, DG, and DB through one channel.

The input signal IS input to the controller 400 may be one of normal planar (or two-dimensional (2D)) image data, three-dimensional (3D) graphic data including 3D spatial coordinates and surface information of an object to be three-dimensionally displayed on a planar surface, and stereoscopic image data including image data of each view point. The input signal IS may include planar image data and stereoscopic data when the display unit 100 displays a planar image and a stereoscopic image together. The controller 400 according to the present exemplary embodiment decides (or selects) one of a 2D driving mode or a 3D driving mode according to an input signal for driving. In more detail, the 2D driving mode is a driving mode that displays a planar image by driving the first and second barriers to transmit an image to be displayed on the display unit as it is, so as to not induce binocular parallax. The 3D driving mode is a driving mode that displays a stereoscopic image by driving one of the first barrier or the second barrier according to a scan direction of the display unit to form a transmission area and a non-transmission area repeatedly (and/or alternately), thereby inducing binocular parallax.

The barrier driver 500 operates as the 2D driving mode or the 3D driving mode according to a barrier driver control signal CONT3. The barrier driver 500 according to the present exemplary embodiment drives the first barrier 110 or the second barrier 120 by being synchronized with an image displayed on the display unit 100. In more detail, the controller 400 generates a scan signal according to a horizontal synchronization signal. The display unit 100 displays images of each row according to scan signals sequentially transferred from the plurality of scan lines S1 to Sn. Here, one of the first barrier 110 or the second barrier 120 is selected according to the scan direction of the display unit 100, and operates when a stereoscopic image is displayed. The barrier driver 500 generates and transfers a plurality of first barrier driving control signals CB_1[1] to CB_1 [p] to control the first barrier 110, and generates and transfers a plurality of second barrier driving control signals CB_2[1] to CB_2[q] to control the second barrier 120. The electronic imaging device according to an embodiment of the present invention will be described in more detail with reference to FIG. 2 to FIG. 5.

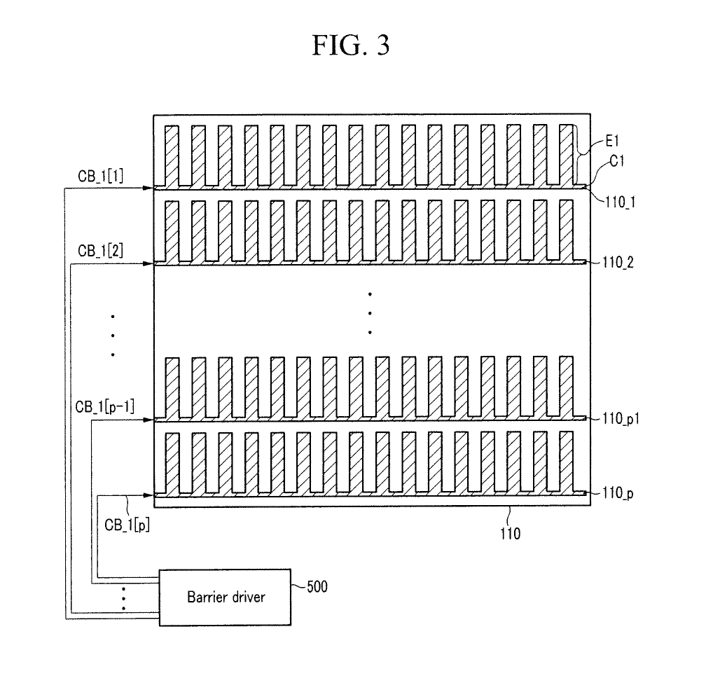

FIG. 3 is a diagram illustrating a first barrier according to an exemplary embodiment of the present invention. The first barrier and a second barrier according to the present exemplary embodiment use a parallax barrier scheme. Hereinafter, the first and second barriers are referred to as being turned-on if the first and second barriers respectively form a non-transmission area and a transmission area by being applied with a regular voltage, and the first and second barriers are referred to as being turned-off if the first and second barriers form only transmission areas.

The first barrier 110 includes a plurality of first sub-barriers 110_1 to 110_{—}p. Each one of the plurality of first sub-barriers 110_1 to 110_{—}p is formed corresponding to at least one of the scan lines. Each first sub-barrier 110_1 to 110_{—}p includes a plurality of first electrodes E1 and a first connection electrode C1. Each first sub-barrier 110_1 to 110_{—}p is turned on in response to a voltage level of the first barrier driving control signal when the first barrier driving control signal is applied. Each of the plurality of first sub barriers 110_1 to 110_{—}p receives a corresponding first barrier driving control signal CB_1[1] and CB_1[p] from the barrier driver 500. Each first sub-barrier 110_{—}i is turned on in response to an on-level of a first barrier driving control signal CB_1[i], where i is a natural number (e.g., positive integer) from 1 to p, and forms a non-transmission area.

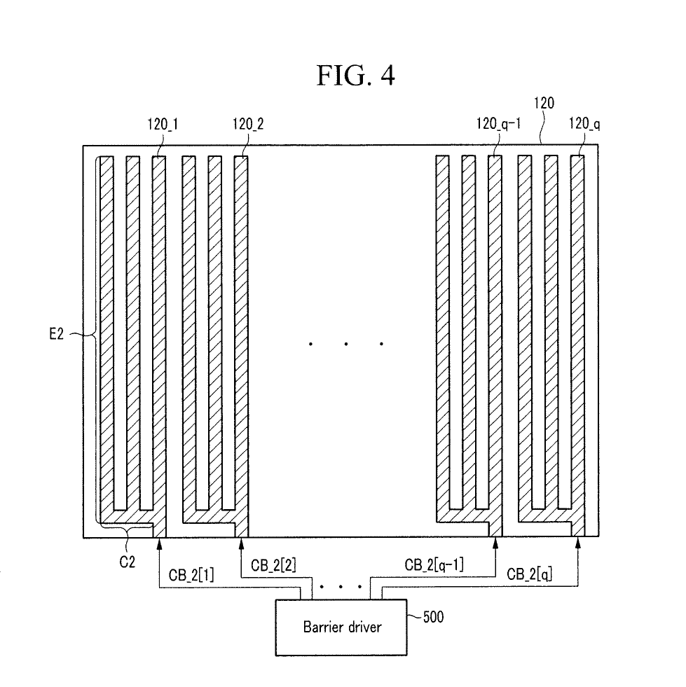

FIG. 4 is a diagram illustrating a second barrier according to an exemplary embodiment of the present invention. The second barrier 120 includes a plurality of second sub-barriers 120_1 to 120_{—}q. Each one of the plurality of second sub-barriers 120_1 to 120_{—}q is formed corresponding to at least one of the scan lines. Each of the plurality of second sub-barriers 120_1 to 120_{—}q includes a plurality of second electrodes E2 and a second connection electrode C2. The plurality of second electrodes E2 are turned on in response to a voltage level of the second barrier driving control signal and become a non-transmission area. Each of the plurality of second sub-barriers 120_1 to 120_{—}q receives a second barrier driving control signal CB_2[1] to CB_2[q] from the barrier driver 500. Each sub-barrier 120_{—}j is turned on in response to an on-level of a second barrier driving control signal CB_2[j], where j is a natural number (e.g., positive integer) from 1 to q, and forms a non-transmission area.

In FIG. 3 and FIG. 4, a normal white barrier is shown, which forms a transmission area during a turned-off period and forms a non-transmission area during a turned-on period. However, the present invention is not limited thereto, and a normal black barrier can be used. Also, the shapes of the first and second barriers shown in FIG. 3 and FIG. 4 are only exemplary embodiments of the present invention, and the present invention is not limited thereto.

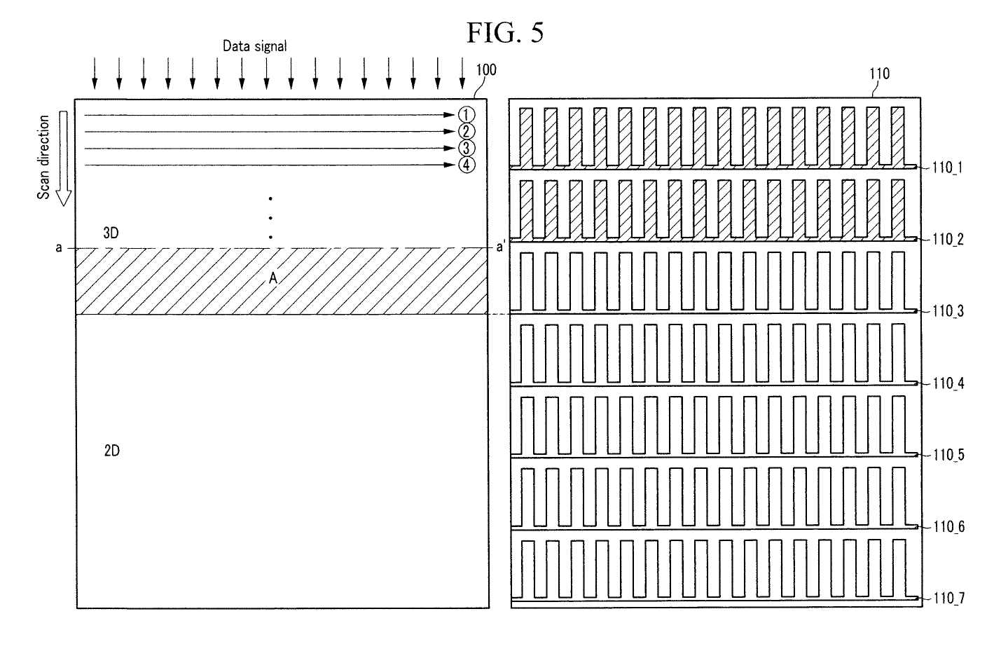

Hereinafter, a method of driving the first and second barriers by being synchronized with an image displayed on the display unit 100 will be described in more detail with reference to FIG. 5 to FIG. 8.

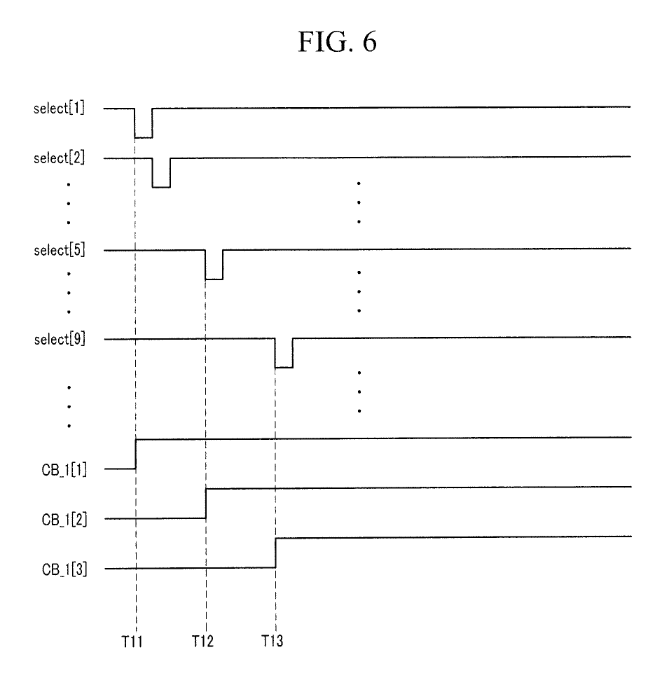

FIG. 5 illustrates a display unit and a first barrier for describing an operation of the display unit and the first barrier according to an exemplary embodiment of the present invention. FIG. 6 illustrates first barrier driving control signals CB_1[1] to CB_1[3] corresponding to selection signals select[1] to select[9]. In FIG. 5, the first barrier 110 is described to include seven sub-barriers 110_1 to 110_7, and one sub-barrier is described to correspond to four scan lines for ease of description and the present invention is not thereby limited. Also, the display unit 100 is described as being set to display a planar image for a previous frame and to display a stereoscopic image for a current frame.

As shown in FIG. 5, the sub-barriers 110_1 and 110_2 include a non-transmission area to display a stereoscopic image. With the line a-a′ as a reference, an upper area displays a stereoscopic image and a lower area displays a planar image. The sub-barrier 110_3 is turned on and forms a non-transmission area by being synchronized with the timing of applying a selection signal select[9] applied along the 9^{th} scan line S9. As described above, the first barrier 110 operates with being synchronized with a selection signal.

That is, the first barrier driving control signal CB_1[1] becomes a high level and the sub-barrier 110_1 is turned on by being synchronized with the timing T11 where the selection signal select[1] drops from a high level to a low level. In the pixel circuit according to the present exemplary embodiment, a switching transistor receiving a selection signal is a p-type transistor. The switching transistor transfers a data signal to a driving transistor when the selection signal is at a low level. That is, the sub-barrier 110_1 is turned on by being synchronized with the timing of displaying an image of one pixel circuit row. Thereby, an area of the display unit 100 corresponding to the scan lines S1 to S4 (\textcircled{1}\textcircled{2}\textcircled{3}\textcircled{4} in FIG. 5) displays a stereoscopic image.

Further, the first barrier driving control signal CB_1 [2] becomes a high level and the sub-barrier 110_2 is turned on by being synchronized with the timing T12 where a selection signal select[5] drops from a high level to a low level. Then, the display unit 100 displays a stereoscopic image on an area corresponding to the scan lines S5 to S8. In an identical (or substantially identical) way, the first barrier driving control signal CB_1[3] becomes a high level, and the sub-barrier 110_3 is turned on by being synchronized with the timing T13 where a selection signal select[9] drops from a high level to a low level. Then, the display unit 100 displays a stereoscopic image on an area A corresponding to the scan lines S9 to S12.

In the same (or substantially the same) way, a stereoscopic image of a current frame is displayed on the entire display unit 100.

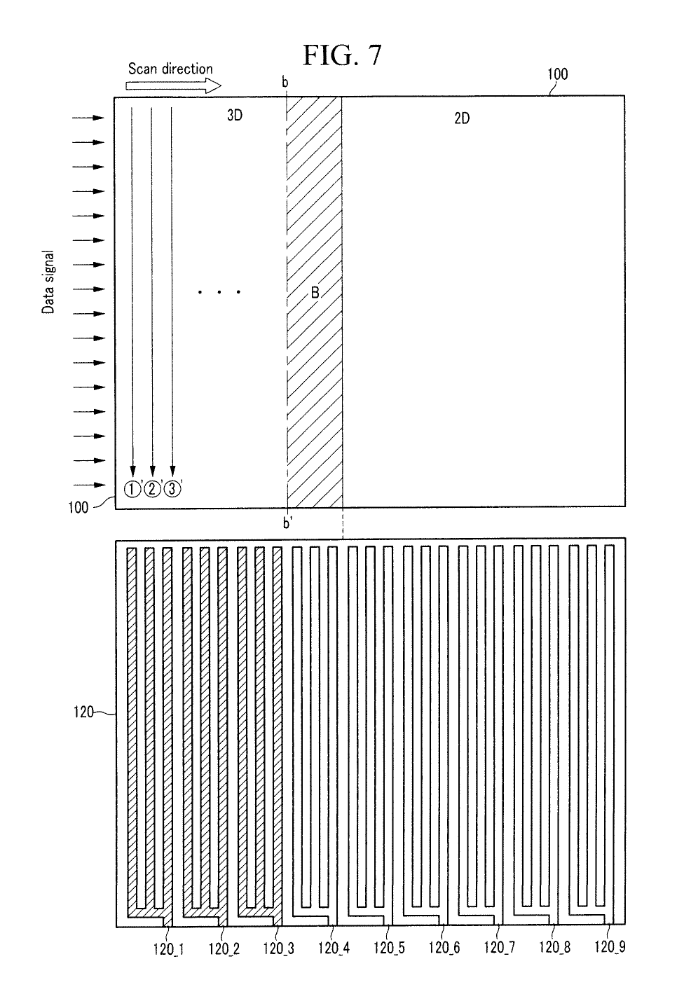

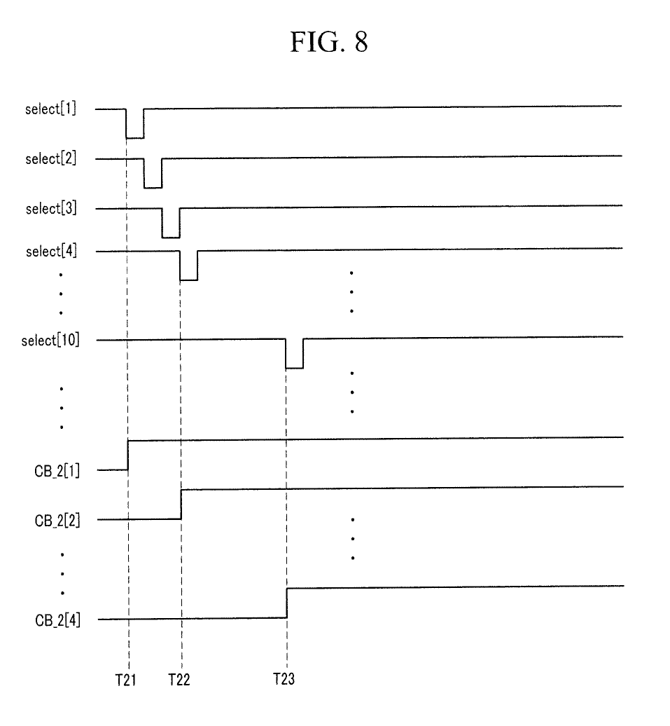

Hereinafter, the operation of a second barrier for displaying a stereoscopic image when a display unit rotates 90° and when a scan direction changes based on a user will be described in more detail with reference to FIG. 7 and FIG. 8.

FIG. 7 illustrates a display unit and a second barrier for describing an operation of the display unit and the second barrier according to an exemplary embodiment of the present invention. FIG. 8 illustrates second barrier driving control signals CB_2[1] to CB_2[4] corresponding to selection signals select[1] to select[10]. For better understanding and ease of description, the second barrier 120 is described to have nine sub-barriers 120_1 to 120_9, and one sub-barrier is described to correspond to three scan lines in FIG. 7. However, it will be appreciated by those skilled in the art that the present invention is not limited thereto. The display unit 100 and the second barrier 120 are described to display a planar image for a previous frame and a stereoscopic image for a current frame.

As shown in FIG. 7, sub-barriers 120_1 to 120_3 include a-non transmission area to display a stereoscopic image. With the line b-b′ as a reference, a stereoscopic image is displayed on the left, and a planar image is displayed on the right. The sub-barrier 120_4 is turned on and forms a non-transmission area by being synchronized with the timing of applying a selection signal select [10] along the 10^{th} signal line S10. In the same way, the second barrier 120 operates by being synchronized with a selection signal.

As shown in FIG. 8, the second barrier driving control signal CB_2[1] becomes a high level and a sub-barrier 120_1 is turned on by being synchronized with the timing T21 where a selection signal select[1] drops from a high level to a low level. The sub-barrier 120_1 is turned on by being synchronized with the timing of displaying an image of one pixel circuit row. Thereby, the display unit 100 displays a stereoscopic image on an area corresponding to the plurality of scan lines S1 to S3 (\textcircled{1}′(\textcircled{2}′\textcircled{3}′ in FIG. 7).

Further, the second barrier driving control signal CB_2[2] becomes a high level and the sub-barrier 120_2 is turned on by being synchronized with the timing T22 where a selection signal select[4] drops from a high level to a low level.

Then, a stereoscopic image is displayed on an area of the display unit 100 corresponding to the scan lines S4 to S6 arranged next to (or to follow) the plurality of scan lines S1 to S3. As described above, the second barrier driving control signal CB_2[4] accordingly becomes a high level, and the sub-barrier 120_4 is turned on by being synchronized with the timing T23 where a selection signal select[10] drops from a high level to a low level. Then, a stereoscopic image is displayed on an area B of the display unit 100.

In view of the foregoing, the electronic imaging device according to the present exemplary embodiment has been described to include both of the first barrier 110 and the second barrier 120. However, the present invention is not limited thereto, and an electronic imaging device may selectively include only one of the first barrier 110 or the second barrier 120.

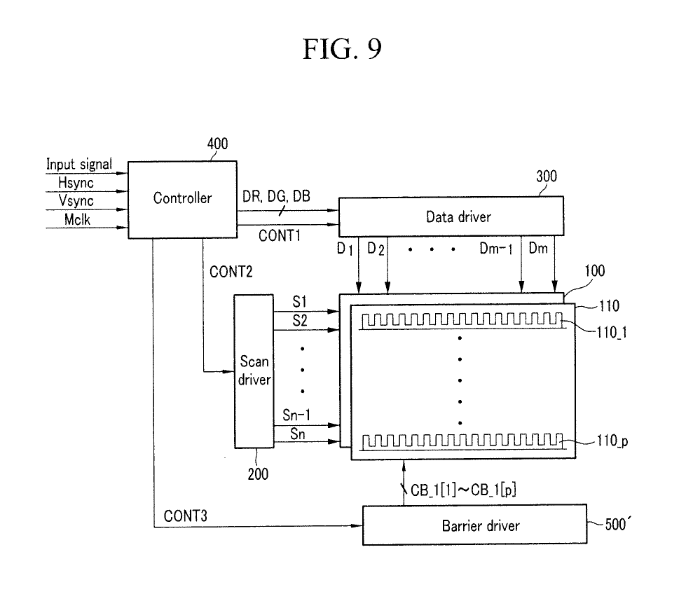

With reference to FIG. 9, an electronic imaging including a first barrier 110 only will be described in more detail below.

FIG. 9 is a diagram schematically illustrating an electronic imaging device according to a second exemplary embodiment of the present invention.

Since the electronic imaging device only includes the first barrier 110 as shown in FIG. 9, a barrier driver 500′ transfers a plurality of first barrier driving control signals CB_1[1] to CB_1 [q] to the first barrier 110.

The display unit 100 and the first barrier 110 are disposed in a first direction shown in the drawing, and operate in a manner substantially the same as shown and described with reference to FIG. 3 when an image is displayed.

Then, when the display unit 100 and the first barrier 110 rotate 90° and a stereoscopic image is displayed, the first barrier 110 turns on all the sub-barriers 110_1 to 110_{—}p regardless of the timing of transferring the plurality of selection signals sequentially along the plurality of scan lines. Thereby, a stereoscopic image is displayed.

An electronic imaging device having a second barrier 120 operates in a manner substantially the same as shown and described with reference to FIG. 3 when an image is displayed.

The electronic imaging devices according to the first and second exemplary embodiments provide sharper image quality using a barrier operated by being synchronized with a selection signal when a planar image changes to a stereoscopic image.

Hereinafter, an electronic imaging device according to another exemplary embodiment of the present invention will be described.

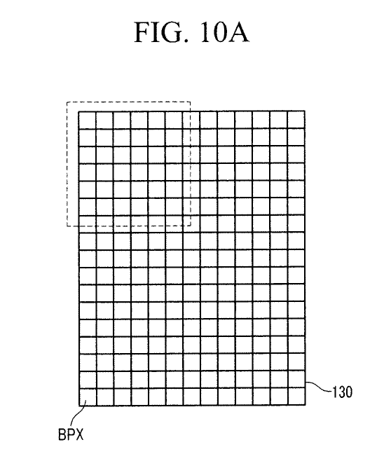

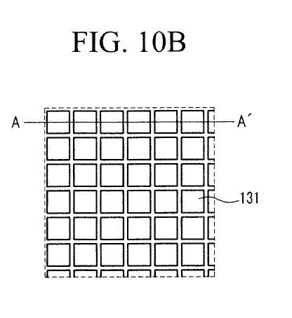

FIGS. 10A and 10B are diagrams schematically illustrating a barrier of an electronic imaging device according to a third exemplary embodiment of the present invention. As shown in FIG. 10A, a barrier 130 includes a plurality of barrier cells BPX formed as a cell unit.

FIG. 10B is an enlarged view of a part of the barrier 130 of FIG. 10B shown by the dotted line.

As shown in FIG. 10B, the barrier cells BPX include transparent electrode cells (ITO cells) 131. The transparent electrode cells 131 are patterned and form the barrier 130.

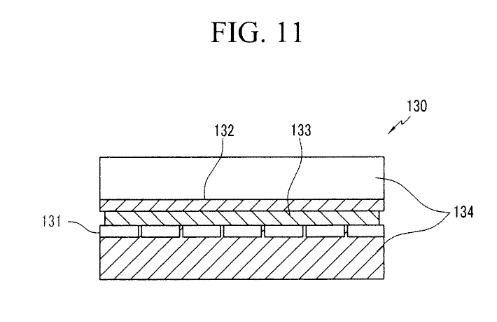

FIG. 11 is a cross-sectional view of the barrier 130 of FIG. 10B taken along the line A-A′.

The barrier 130 includes a common transparent electrode (common ITO) 132, a liquid crystal layer 133 and glass substrates 134.

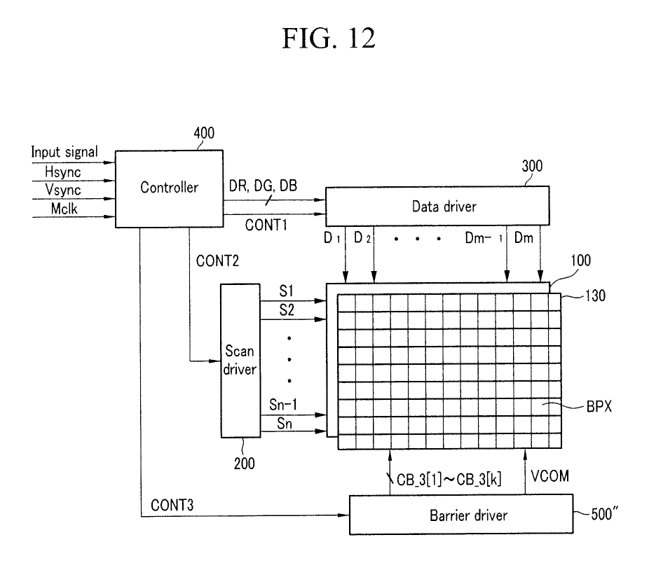

Hereinafter, an electronic imaging device according to the third exemplary embodiment of the present invention will be described in more detail with reference to FIG. 12.

FIG. 12 is a diagram illustrating an electronic imaging device according to the third exemplary embodiment of the present invention. Except for a barrier 130 and a barrier driver 500″, the other constituent elements and the operation thereof are identical (or substantially identical) to that of the first exemplary embodiment of the present invention.

The barrier driver 500″ applies a common voltage VCOM to the common transparent electrode 132, and applies a plurality of barrier driving voltages CB_3[1] to CB_3[k] to the transparent electrode cells 131 of the plurality of barrier cells BPX according to an image displayed on the display unit 100. In more detail, the barrier driver 500″ applies barrier driving voltages CB_3[1] to CB_3[k] to the transparent electrode cells 131 by being synchronized with the timing of displaying an image at a plurality of pixels along a scan direction of the display unit 100.

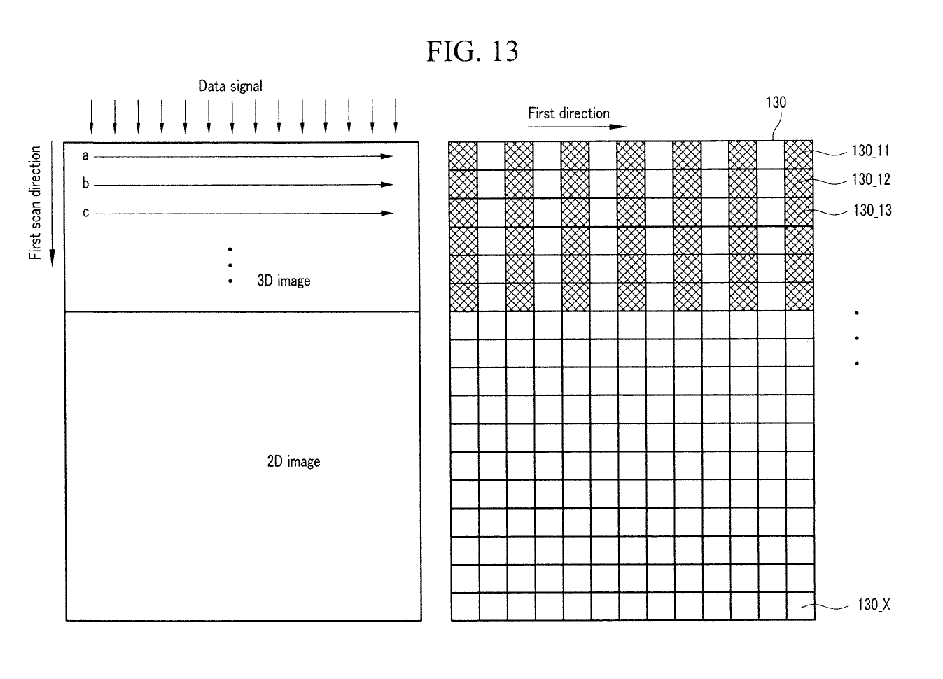

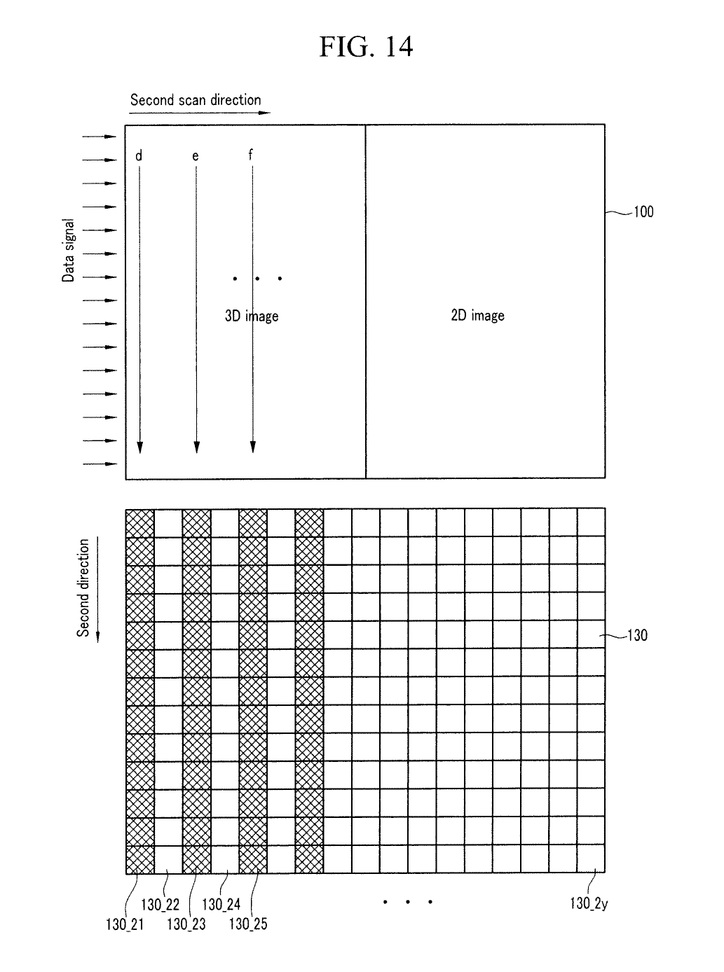

Hereinafter, the operation of the barrier driver 500″ will be described with reference to FIG. 13 and FIG. 14.

FIG. 13 illustrates operation of a barrier when a planar image changes to a stereoscopic image in an electronic imaging device according to the third exemplary embodiment of the present invention.

As shown in FIG. 13, a plurality of barrier cells formed in a first direction form a first sub-barrier corresponding to a first scan direction. The barrier 130 includes a plurality of first sub-barriers 130_11 to 130_{—}x.

When a selection signal is applied to a scan line (a) and a data signal is applied to each pixel of the display unit 100 so as to display an image, a barrier driving voltage is transferred to transparent electrode cells 131 of odd numbered barrier cells BPX among the transparent electrode cells 131 of the plurality of barrier cells BPX forming the first sub-barrier 130_11 of the barrier 130. In the same (or substantially the same) way, when a selection signal is applied to a scan line (b) and a data signal is applied to each pixel of the display unit 100 so as to display an image, a barrier driving voltage is applied to transparent electrode cells 131 of odd numbered barrier cells BPX among the transparent electrode cells 131 of the plurality of barrier cells BPX forming the first sub-barrier 130_12 of the barrier 130. When a selection signal is applied to the scan line (c) and a data signal is applied to each pixel of the display unit 100 so as to display an image, a barrier driving voltage is transferred to transparent electrode cells 131 of odd numbered barrier cells BPX among the transparent electrode cells 131 of the plurality of barrier cells BPX forming the first sub-barrier 130_13 of the barrier 130. When a barrier driving voltage is transferred to the transparent electrode cells 131, the barrier cells BPX become non-transmission areas. In an identical (or substantially identical) way, the plurality of barrier cells BPX forming the barrier 130 operate by being synchronized with a stereoscopic image displayed on the display unit 100 in the first scan direction. The plurality of the first sub-barriers 130_11 to 130_{—}x forming the barrier 130 according to the third exemplary embodiment operate along the first scan direction. Also, the present invention is not limited to only driving the odd numbered barrier cells among the plurality of first sub-barriers. The even numbered barrier cells may be driven, and the barrier cells can be differently driven according to other driving methods. In the case of a time-division driving scheme, the even numbered barrier cells may be driven after driving the odd numbered barrier cells, or the odd numbered barrier cells may be driven after driving the even numbered barrier cells.

FIG. 14 is a diagram illustrating operation of a barrier when the display unit of FIG. 13 rotates 90° and a planar image changes to a stereoscopic image in a second scan direction.

As shown in FIG. 14, a plurality of barrier cells formed in a second direction form one of the second sub-barriers corresponding to the second scan direction. The barrier 130 includes a plurality of second sub-barriers 130_21 to 130_2y.

When a selection signal is applied to the scan line (d) and a data signal is applied to each pixel of the display unit 100 so as to display an image, a barrier driving voltage is applied to transparent electrode cells 131 of a plurality of barrier cells BPX forming the second sub-barrier 130_21 of the barrier 130. As a result, the second sub-barrier 130_21 becomes a non-transmission area. Likewise, a barrier driving voltage is applied to transparent electrode cells 131 of a plurality of barrier cells BPX forming the second sub-barrier 130_22 by being synchronized with the timing of applying a selection signal to the scan line (e). As a result, the second sub-barrier 130_22 becomes a non-transmission area.

A barrier driving voltage is applied to transparent electrode cells 131 of a plurality of barrier cells BPX forming the second sub-barrier 130_23 by being synchronized with the timing of applying a selection signal to the scan line (f). As a result, the second sub-barrier 130_23 becomes a non-transmission area. In the same way, the plurality of barrier cells BPX forming the barrier 130 operate by being synchronized with a stereoscopic image displayed along the second scan direction. In this manner, odd numbered second sub-barriers among the plurality of the second sub-barriers 130_21 to 130_2y are driven by being synchronized with the timing of transferring a selection signal to a scan line along the second scan direction, and the odd numbered second sub-barriers become non-transmission areas. The barrier 130 according to the third exemplary embodiment of the present invention was described to drive the odd numbered second sub-barriers among the plurality of second sub-barriers. However, the even numbered second sub-barriers may be driven, or the second sub-barriers may be differently driven according to other suitable driving methods. In more detail, according to a time-division driving scheme, the even numbered second sub-barriers may be driven after driving the odd numbered second sub-barriers, or the odd numbered second sub-barriers may be driven after driving the even numbered second sub-barriers.

The present invention can be applicable when a stereoscopic image is displayed at a certain (or predetermined) area of the display unit 100.

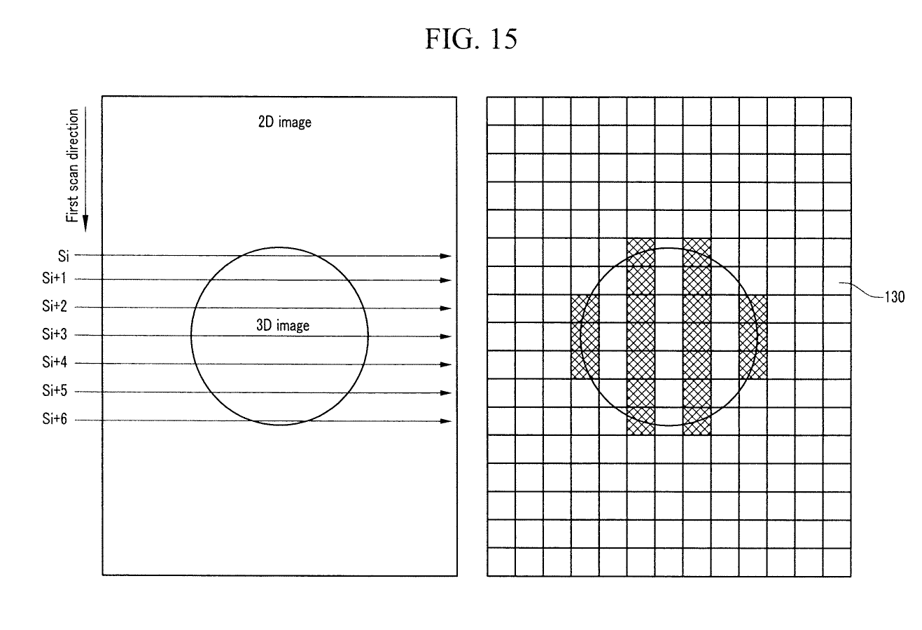

FIG. 15 illustrates a display unit 100 displaying a stereoscopic image on a certain (or predetermined) area according to a third exemplary embodiment of the present invention.

As shown in FIG. 15, a barrier driving voltage is transferred to a plurality of barrier cells BPX corresponding to an area S among barrier cells BPX of the barrier 130 by being synchronized with the timing of transferring a selection signal to scan lines Si to Si+6 that correspond to the area S displaying a stereoscopic image. Then, a plurality of barrier cells BPX become a non-transmission area. Therefore, an image displayed on the area S of the display unit 100 is shown to a user as a stereoscopic image.

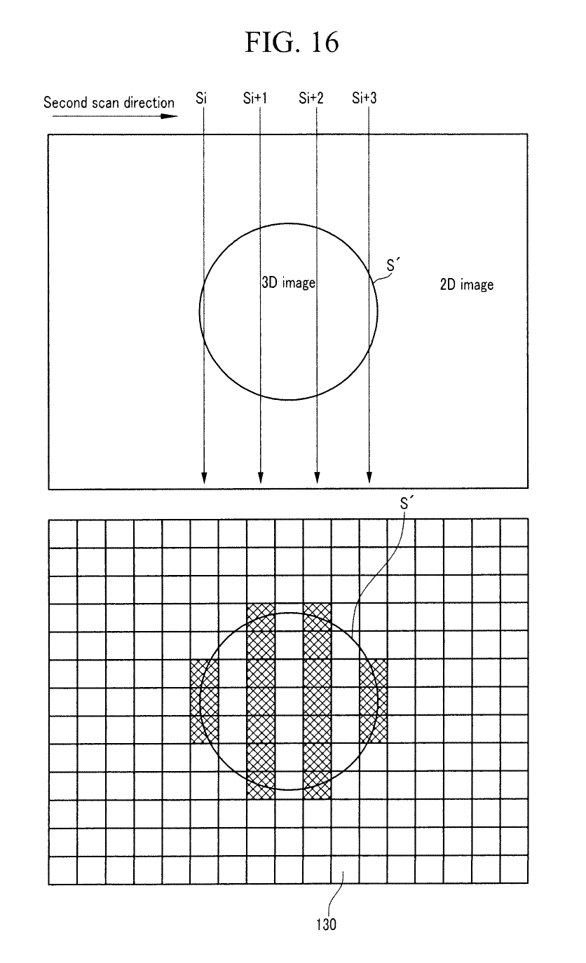

FIG. 16 illustrates a stereoscopic image displayed at the certain (or predetermined area) of a display unit 100 according to the third exemplary embodiment of the present invention. That is, FIG. 16 shows the barrier 130 in a second scan direction.

As shown in FIG. 16, a barrier driving voltage is transferred to a plurality of barrier cells BPX corresponding to an area S′ among barrier cells BPX of the barrier 130 by being synchronized with the timing of transferring a selection signal to scan lines Si to Si+3 corresponding to the area S′ that displays a stereoscopic image. Then, a plurality of the barrier cells BPX become a non-transmission area. Therefore, an image displayed on the area S′ of the display unit 100 is shown to a user as a stereoscopic image.

As described above, the barrier according to the third embodiment operates by being synchronized with the timing of transferring a selection signal to corresponding scan lines. That is, the barrier is driven by being synchronized with a stereoscopic image displayed on the display unit. Therefore, the electronic imaging device according to the present embodiment improves (and/or provides excellent) image quality.

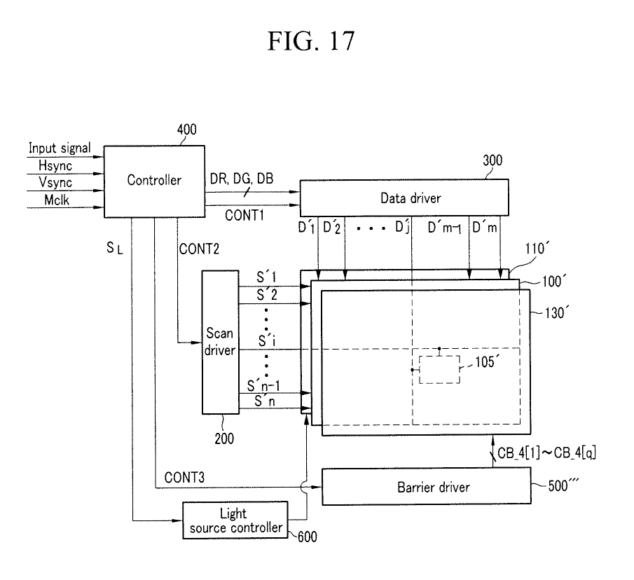

Hereinafter, an electronic imaging device according to a fourth exemplary embodiment of the present invention will be described with reference to FIG. 17.

FIG. 17 schematically illustrates an electronic imaging device according to the fourth exemplary embodiment of the present invention.

As shown in FIG. 17, the electronic imaging device according to the fourth exemplary embodiment of the present invention further includes a display unit (or display region) 100′ for displaying an image using a liquid crystal layer, a light source 110′, and a light source controller 600. The display unit 100′ includes a plurality of scan lines S′1 to S′n that transfer select signals, a plurality of data lines D′1 to D′m that transfer data signals and a plurality of pixel 105′ for displaying an image using a liquid crystal layer. The barrier 130′ according to the fourth exemplary embodiment of the present invention operates in the same manner (or substantially the same manner) as the barrier according to the third exemplary embodiment of the present invention. The barrier driver 500′″ transfers barrier driving voltages CB_4[1] to CB_4[w] to the barrier 130′. The electronic imaging device according to the fourth exemplary embodiment of the present invention is not limited thereto. A stereoscopic image can be displayed using the barrier according to the first and second exemplary embodiments.

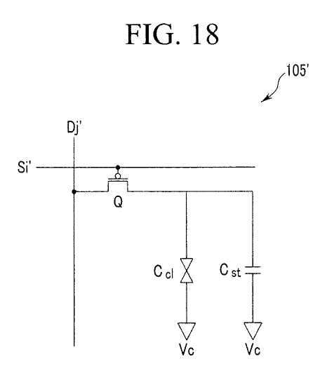

FIG. 18 illustrates a pixel circuit according to the fourth exemplary embodiment of the present invention.

As shown in FIG. 18, a pixel circuit of a pixel 105′ includes a switch Q, a liquid crystal layer Ccl, and a storage capacitor Cst. The switch Q is turned on in response to a selection signal transferred by a scan line Si′. A p-type transistor is used as the switch Q according to the fourth exemplary embodiment of the present invention. When the switch Q is turned on by the selection signal of a significantly low level, a data signal of a data line Dj′ is transferred through the turned-on switch Q, and the liquid crystal layer Ccl is driven according to a voltage difference between the voltage of a data signal and a common voltage Vc, thereby refracting light from the light source 110′. Here, the storage capacitor Cst uniformly maintains (or sustains) a voltage difference between both ends of the liquid crystal layer Ccl.

In one embodiment, the light source 110′ includes light emitting diodes of red R, green G, and blue B colors, and outputs lights of red R, green G, and blue B colors to the display unit 100′. In more detail, the light emitting diodes of red R, green G, and blue B colors of the light source 110′ output lights to a R subpixel, a G subpixel, and a B subpixel of the display unit 100′, respectively.

The light source controller 600 controls a time of turning on the light emitting diodes of the light source 110′ in response to a control signal SL output from the controller 400. Here, a period of applying an analog data voltage from a data driver 300 to a data line and a period of turning on the light emitting diodes of red R, green G, and blue B colors by the light source controller 600 can be synchronized by a control signal provided by the controller 400.

An electronic imaging device according to an embodiment of the present invention includes an optical element layer operated by being synchronized with a selection signal when a planar image changes to a stereoscopic image.

Also, an electronic imaging device according to an embodiment of the present invention provides sharper image quality when a planar image changes to a stereoscopic image.

A barrier including barrier cells according to an embodiment of the present invention operates by being synchronized with a selection signal. Therefore, an electronic imaging device according to an embodiment of the present invention displays a sharper stereoscopic image.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electronic imaging device comprising:
a display unit comprising a plurality of scan lines for transferring a plurality of selection signals, a plurality of data lines for transferring a plurality of data signals, and a plurality of pixels connected to the pluralities of data lines and scan lines; and
a barrier layer adapted to operate in synchronization with the selection signals,
wherein the barrier layer comprises at least one sub-barrier corresponding to a first scan line among the plurality of scan lines, and is adapted to operate in synchronization with at least one of the selection signals transferred to the first scan line.

2. The electronic imaging device of claim 1, wherein the at least one sub-barrier comprises at least one first sub-barrier formed to correspond to at least one of the plurality of scan lines in a first direction when the plurality of selection signals are transferred to the plurality of scan lines in the first direction.

3. The electronic imaging device of claim 2, wherein at least two scan lines of the plurality of scan lines correspond to the at least one first sub-barrier, and the at least one first sub-barrier is adapted to operate in synchronization with a first applied selection signal among the selection signals applied to the at least two scan lines.

4. The electronic imaging device of claim 3, wherein the at least one first sub-barrier comprises:
a plurality of first electrodes corresponding to the plurality of data lines; and
a first connection electrode for connecting the plurality of first electrodes.

5. The electronic imaging device of claim 4, wherein a first voltage is applied to the plurality of first electrodes by being synchronized with the first applied selection signal when a stereoscopic image is displayed on the display unit.

6. The electronic imaging device of claim 2, wherein the at least one sub-barrier comprises at least one second sub-barrier formed to correspond to at least one of the plurality of scan lines in a second direction when the plurality of selection signals are transferred to the plurality of scan lines in the second direction.

7. The electronic imaging device of claim 1, wherein the barrier layer further comprises a first barrier layer and a second barrier layer, wherein the first barrier layer comprises at least one first sub-barrier of the at least one sub-barrier, formed to correspond to at least one of the plurality of scan lines in a first direction when the plurality of selection signals are transferred to the plurality of scan lines in the first direction, and wherein the second barrier layer comprises at least one second sub-barrier of the at least one sub-barrier, formed to correspond to at least one of the plurality of scan lines in a second direction when the plurality of selection signals are transferred to the plurality of scan lines in the second direction.

8. The electronic imaging device of claim 7, wherein at least two scan lines of the scan lines correspond to the at least one second sub-barrier, and the at least one second sub-barrier is adapted to operate in synchronization with a first applied selection signal among the selection signals applied to the at least two scan lines.

9. The electronic imaging device of claim 8, wherein the at least one second sub-barrier comprises:
a plurality of second electrodes corresponding to the plurality of scan lines; and
a second connection electrode for connecting the second electrodes.

10. The electronic imaging device of claim 9, wherein a first voltage is applied to the plurality of second electrodes by being synchronized with the first applied selection signal when a stereoscopic image is displayed on the display unit.

11. The electronic imaging device of claim 1, wherein each of the pixels comprises an organic light emitting element.

12. The electronic imaging device of claim 1, further comprising a light source for providing light to the display unit, wherein each of the pixels of the display unit includes a liquid crystal layer.

13. An electronic imaging device comprising:
a display unit comprising a plurality of scan lines for transferring a plurality of selection signals, a plurality of data lines for transferring a plurality of data signals, and a plurality of pixels connected to the pluralities of data lines and scan lines; and
a plurality of barriers comprising a plurality of barrier cells,
wherein the plurality of barrier cells are adapted to form a plurality of first sub-barriers in a first direction corresponding to a first scan direction of transferring the plurality of selection signals to the plurality of scan lines, respectively, and the first sub-barriers are adapted to synchronize with the selection signals corresponding to a plurality of first scan lines among the plurality of scan lines.

14. The electronic imaging device of claim 13, wherein the plurality of barrier cells are further adapted to form a plurality of second sub-barriers in a second direction corresponding to a second scan direction of transferring the plurality of selection signals to the plurality of scan lines, and the second sub-barriers are adapted to operate in synchronization with the selection signals of a plurality of second scan lines among the plurality of scan lines.

15. The electronic imaging device of claim 14, wherein the plurality of barrier cells are disposed corresponding to the plurality of pixels,
wherein a first barrier cell and a second barrier cell among the plurality of barrier cells forming a first barrier corresponding to the first scan lines of an area for displaying a stereoscopic image in the display unit are adjacent to each other, and
wherein one of the first barrier cell or the second barrier cell is a non-transmission area.

16. The electronic imaging device of claim 14, wherein the plurality of second sub-barriers are disposed corresponding to the plurality of second scan lines, and
wherein a first set of the second sub-barriers corresponding to the second scan lines of an area for displaying a stereoscopic image in the display unit forms a non-transmission area, and a second set of second sub-barriers adjacent to the second sub-barriers in the stereoscopic display area forms a transmission area.

17. An electronic imaging device comprising:
a display unit comprising a plurality of scan lines for transferring a plurality of selection signals, a plurality of data lines for transferring a plurality of data signals, and a plurality of pixels connected to the pluralities of data lines and scan lines; and
a barrier comprising a plurality of barrier cells,
wherein a plurality of first barrier cells of the plurality of barrier cells corresponding to a first area for displaying a stereoscopic image in the display unit are adapted to operate in synchronization with a timing of the selection signals transferred to each of the plurality of scan lines corresponding to the first area.

18. The electronic imaging device of claim 17, wherein a first barrier cell and a second barrier cell of the first barrier cells are adjacent to each other in a first direction, and wherein one of the first barrier cell or the second barrier cell is a non-transmission area.

19. The electronic imaging device of claim 18, wherein a plurality of second barrier cells of the plurality of barrier cells continuously form a non-transmission sub-barrier in a second direction, and wherein other sub-barriers, formed by a plurality of third barrier cells of the plurality of barrier cells, adjacent to the non-transmission sub-barrier form a transmission area.

20. The electronic imaging device of claim 17, wherein the first barrier cells continuously form a non-transmission sub-barrier in a first direction, and wherein other sub-barriers, formed by a plurality of second barrier cells of the plurality of barrier cells, adjacent to the non-transmission sub-barrier form a transmission area.
